(19) United States
(12) Patent Application Publication
(10) Pub. No.: US 2025/0236685 A1
(43) Pub. Date: Jul. 24, 2025

(54) DEGRADABLE POLYMERS

(71) Applicant: The Trustees of Boston College, Chestnut Hill, MA (US)

(72) Inventors: Jia Niu, Lexington, MA (US); Nachuan Jiang, Brighton, MA (US)

(21) Appl. No.: 19/036,856

(22) Filed: Jan. 24, 2025

Related U.S. Application Data
(60) Provisional application No. 63/624,376, filed on Jan. 24, 2024.

(51) Int. Cl. C08B 37/00

(52) U.S. Cl. CPC C08B 37/00

(57) ABSTRACT

A polymer that is degradable and contains an acetyl group and a saccharide group. The acetyl group and the saccharide group are bonded to each other through an ester bond. Also provided is a method of preparing the polymer.

### CROSS REFERENCE TO RELATED APPLICATION

The application claims the benefit of priority to U.S. Application Ser. No. 63/624,378 filed on Jan. 24, 2024, the entire content of which is incorporated by reference.

### GOVERNMENT SUPPORT

The invention was made with government support under Grant Numbers CHE 1944512 and CHE 2117246 awarded by the National Science Foundation. The government has certain rights in the invention.

### FIELD OF INVENTION

The disclosure relates to degradable polymers and their preparations.

### BACKGROUND

Degradable polymers have shown promises in biomedical applications and offer a potential solution to address the accumulation of persistent plastics in the environment.

During the past decade, significant efforts have been devoted to the development of degradable polymers including biopolymers in nature, e.g., nucleic acids, proteins, and polysaccharides. See Xiao et al., Prog. Polym. Sci. 74, 78-116 (2017); Zhu et al., Nature 540, 354-362 (2016); and Zhang et al., J. Controlled Release 219, 355-368 (2015). Carbohydrate copolymers have been generated via anionic and cationic polymerizations. See Dane et al., J. Am. Chem. Soc. 134, 16255-64 (2012); and Shen et al., J. Am. Chem. Soc. 145, 15405-13 (2023). Nevertheless, anionic and cationic polymerization is suitable for only a small number of specific monomers and cannot be utilized to prepare a large variety of polymers. On the other hand, radical polymerization, which is widely used on vinyl monomers with diverse functional groups, remains underutilized for producing carbohydrate-based degradable polymers.

Cyclic ketene acetals (CKAs) have been developed to prepare degradable polymers via radical ring-opening polymerization (rROP). See Agarwal, Polym. Chem. 1, 953-964 (2010); Tardy et al., Chem. Rev. 117, 1319-1406 (2017); Tardy, et al., Angew. Chem., Int. Ed 59, 14517-26 (2020); and Pesenti, ACS Macro Lett. 9, 1812-1835 (2020). Despite recent progresses, CKAs still suffer from two major limitations: (1) significant non-degradable motifs in the polymer backbone as a result of ring-retaining side reactions during polymerization of CKAs and (2) low reactivity of CKAs in the copolymerization with vinyl monomers, leading to uneven incorporation and necessitating a high feeding ratio of CKAs. In a recent example reported by Buchard et al., 50% CKA was fed to a polymerization reaction and achieved only 11.9% incorporation of degradable ester groups, with 21.1% non-degradable motifs derived from side reactions. See Hardy and Buchard et al., ACS Macro Lett. 12, 1443-49 (2023).

There is a need to develop efficient polymerization methods to prepare degradable polymers from CKAs.

### SUMMARY

This invention is based on an unexpected discovery of degradable polymers prepared from efficient polymerization reactions of saccharide CKAs.

Accordingly, one aspect of this invention relates to a polymer having at least 10 repeat units, each of which contains an acetyl moiety —CR₁R₂C(O)— and a saccharide moiety. The acetyl moiety and the saccharide moiety are bonded to each other through an ester bond, namely —C(O)—O—, —C(O)— being a part of the acetyl moiety and —O— being a part of the saccharide moiety, and each of R₁ and R₂, independently, is H, halo, C₁-C₃ alkyl, or phenyl.

The polymer can have one or any combination of the following features:
(i) the saccharide moiety is derived from glucose, mannose, galactose, rhamnose, xylose, arabinose, lactose, maltose, or glucosamine;
(ii) each repeat unit has a pyranose ring and the acetyl moiety as shown in formula I below:

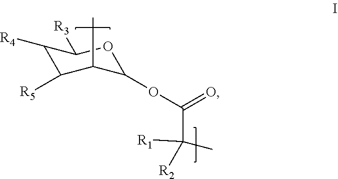

in which each of the bonds connecting to the pyranose ring is either axial or equatorial; and R₃ is H, CH₃, or CH₂OR₃′, R₄ is OR₄′, R₅ is OR₅′, and each of R₃′, R₄′, and R₅′, independently, is H, acetyl, benzyl, pivaloyl, benzoyl, C₁-C₆ alkyl, or a monosaccharide substituent; preferably R₃′ is H, acetyl, benzyl, pivaloyl, benzoyl, or C₁-C₆ alkyl. R₄′ is H, acetyl, benzyl, pivaloyl, benzoyl, C₁-C₆ alkyl, or a monosaccharide substituent (e.g., a glucose substituent or a galactose substituent); and R₅′ is H, acetyl, benzyl, pivaloyl, benzoyl, or C₁-C₆ alkyl;
(iii) each of R₁ and R₂ is H;
(iv) each of the repeat units is represented by one of formulas II, III, and IV as shown below:

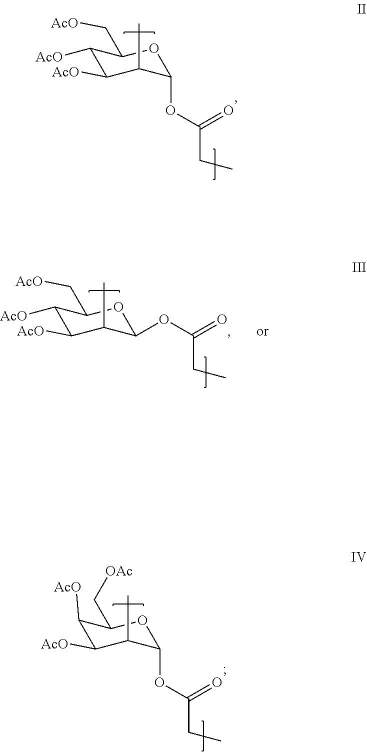

(v) the number average molecular weight of the polymer is 500 Da to 20,000,000 Da (e.g., 1000 Da to 10,000,000 Da, 1500 Da to 5,000,000, 1800 Da to 1,000,000 Da, and 2000 Da to 500,000 Da), preferably 3000 Da to 50,000 Da, 3000 Da to 200,000 Da, 5,000 Da to 400,000 Da, 10,000 Da to 300,000 Da, 10,000 to 40,000 Da, 20,000 Da to 200,000 Da, or 20,000 Da to 30,000 Da;
(vi) the number of the repeat units are in the range of 10 to 20,000 (e.g., 10 to 10,000, 10 to 5,000, 10 to 150, 30 to 15,000, 30 to 9,000, 30 to 3,000, 30 to 1,000, 30 to 500, 30 to 120, 60 to 12,000, 60 to 6,000, 60 to 800, 60 to 200, and 60 to 90); optionally the polymer is a homopolymer;
(vii) the polymer is a co-polymer further comprising one or more repeat units derived from a vinyl monomer (e.g., an acrylate, an acrylamide, a maleimide, a styrene, vinyl acetate, and vinyl amide);
(viii) the polymer is a co-polymer further comprising (i) one or more repeat units derived from methyl acrylate, ethyl acrylate, 2-ethylhexyl acrylate, butyl acrylate, trimethylolpropane triacrylate, methyl methacrylate, ethyl methacrylate, butyl methacrylate, hydroxyethyl methacrylate, glycidyl methacrylate, N,N-dimethyl acrylamide, styrene, vinyl acetate, or N-vinylcarbazole and (ii) one or more repeat units derived from N-phenylmaleimide or N-methylmaleimide; and
(ix) the polymer has the following formula V:

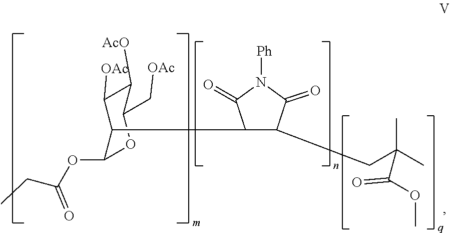

in which m:n:q is 1:(0-10):(0-30); n and q are not both 0; and the number average molecular weight is 1,000 Da to 10,000,000 Da, preferably 3,000 Da to 1,000,000 Da (e.g., 10,000 Da to 300,000 Da, 50,000 Da to 200,000 Da, 5,000 Da to 800,000 Da, and 20,000 Da to 500,000 Da). Formula V shows the possible total number of each repeat unit (including the saccharide moiety, maleimide moiety, and acrylate moiety), with m being 50 to 20,000 (e.g., 100 to 10,000 and 200 to 5000), n being 0-200,000 (e.g., 100 to 100,000 and 500 to 50,000), and q being 0-600,000 (e.g., 300 to 300,000 and 6,000 to 150,000).

Another aspect of this invention relates to a method of preparing the polymer as described above. The method includes the steps of: (i) providing a reaction mixture containing a saccharide-ketene acetal comprising a saccharide moiety and a ketene acetal moiety, wherein the saccharide moiety has a pyranose or furanose ring having C1 and C2 positions, and the ketene acetal moiety connects to the saccharide moiety through two ether bonds on the C1 and C2 positions, and (ii) initiating a radical ring-opening polymerization reaction, thereby obtaining the polymer of claim 1.

Preferred saccharide moieties are those derived from a monosaccharide having a pyranose ring. The ketene moiety is bonded to the pyranose ring on both the C1 and C2 positions to form a five membered cyclic ketene acetal. Exemplary monosaccharides include glucose, mannose, galactose, rhamnose, xylose, arabinose, lactose, maltose, and glucosamine. In some embodiments, the reaction mixture further contains a vinyl monomer and a maleimide monomer. Optionally, the reaction mixture further contains a RAFT reagent, such as

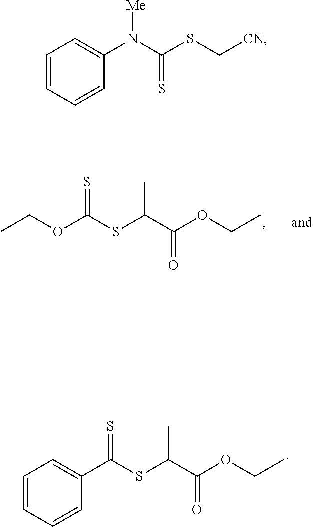 [SMILES: CN(C(=S)SCC#N)c1ccccc1 ; CCOC(=O)C(C)SC(=S)OCC ; CCOC(=O)C(C)SC(=S)c1ccccc1]

The saccharide-ketene acetal can be prepared by reacting a saccharide halide having a halide on the C1 position and O-acetyl on the C2 position, and the halide and O-acetyl are on the same side of the pyranose ring (namely, on the cis position).

The polymerization reaction is typically initiated through adding to the reaction mixture a radical initiator at a temperature of 35° C. or higher, e.g., by adding 2,2′-azobisisobutyro-nitrile (AIBN) as an initiator at a temperature of 40° C. to 140° C. (e.g., 45° C. to 135° C., 50° C. to 140° C., 60° C. to 125° C., and 65° C. to 120° C.).

The details of the invention are set forth in the definitions and the detailed description below. Other features, objects, and advantages of the invention will be apparent from the following actual examples and claims.

### DETAILED DESCRIPTION

The polymers of this invention are prepared by polymerization of certain saccharide-CKA monomers such as a five-membered CKA fused with a saccharide furanose or pyranose ring at C1 and C2 position. Saccharide-CKA monomers are activated probably due to the anomeric effect and the additional twist of the ring structure caused by the 1,2-cis substitution on C1 and C2, leading to higher reactivity in polymerization including both homopolymerization and copolymerization. In homopolymerization, a radical initiator generates a free radical e.g., by heat or by irradiation, which then activates the CKA monomer thereby starting a chain reaction to produce a polymer. In a copolymerization, a maleimide is preferably added to the mixture together with vinyl monomers to improve the incorporation of CKA monomers to vinyl monomers and maleimide monomers.

Exemplary saccharide-CKA monomers have the following formula:

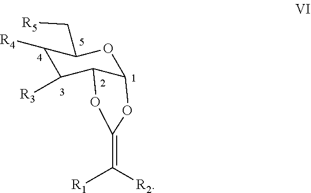

In the formula above, each of R₁-R₅ has been defined above in the Summary section. Each carbon atom on the pyranose ring has been numbered as shown in formula VI. The five-membered CKA ring is fused to the saccharide pyranose ring through two ether bonds, each connects to one of the C1 and C2 carbon atoms. The two ether bonds are in the cis conformation, e.g., they are on the same side of the pyranose ring. As shown in formula VI, the two ether bonds are at the bottom of the pyranose ring. On the other hand, they can be on the top of the pyranose ring. Due to their cis conformation, it is preferable that one of the ether bonds is axial and the other is equatorial on the ring.

As to R₃, R₄, and R₅, they can also be either axial or equatorial. Nevertheless, their conformation might have a positive or negative impact on the reaction rate or the product yield of a polymer prepared therefrom in view of their hindrance effect to the polymerization reaction. Preferably, each of R₃, R₄, and R₅ is in an equatorial conformation.

Exemplary saccharide-CKA monomers include those derived from glucose, mannose, and galactose with structures shown below.

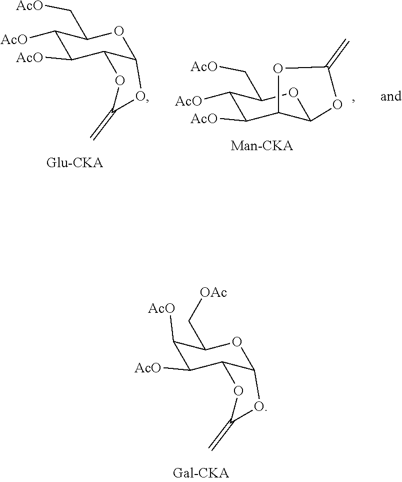 [SMILES: C=C1OC2OC(COC(C)=O)C(OC(C)=O)C(OC(C)=O)C2O1 ; C=C1OC2OC(COC(C)=O)C(OC(C)=O)C(OC(C)=O)C2O1 ; C=C1OC2OC(COC(C)=O)C(OC(C)=O)C(OC(C)=O)C2O1]

In addition to glucose, mannose, and galactose, other monosaccharides are also suitable. Examples include rhamnose, xylose, arabinose, and glucosamine.

Other than the pyranose structure above, it is possible to use a five-membered furanose structure of a saccharide-CKA for preparing the polymer of this invention.

Preferably as shown above, the saccharide is a monosaccharide. Nevertheless, it is possible to use a disaccharide, an oligosaccharide (i.e., having at least two monosaccharide monomers) or a polysaccharide (i.e., having 10 or more monosaccharide monomers) in the saccharide-CKAs in preparing polymers of the invention. The polymers prepared from these CKAs will have disaccharide, oligosaccharide, or polysaccharide segments as repeat units in the backbone of the polymers.

Monosaccharides, disaccharides, oligosaccharides, and polysaccharides include their derivatives modified by protecting the —OH groups such as alkylated carbohydrates (e.g., one or more hydroxyl groups that are methylated, ethylated, acetylated, or benzoylated).

The saccharide CKAs can be prepared using methods well known in the art. See, for example, R. Larock, Comprehensive Organic Transformations (2^{nd} Ed., VCH Publishers 1999); P. G. M. Wuts and T. W. Greene, Greene's Protective Groups in Organic Synthesis (4th Ed., John Wiley and Sons 2007); L. Fieser and M. Fieser, Fieser and Fieser's Reagents for Organic Synthesis (John Wiley and Sons 1994); L. Paquette, ed., Encyclopedia of Reagents for Organic Synthesis (2nd ed., John Wiley and Sons 2009); Agarwal, Polym. Chem. 1, 953-964 (2010); Tardy et al., Chem. Rev. 117, 1319-1406 (2017); Pesenti et al., ACS Macro Lett. 9, 1812-35 (2020); Sznaidman et al., J. Org. Chem. 60, 3942-43 (1995); and Ko et al., Org. Lett. 11, 609-612 (2009).

Saccharide-CKAs have been prepared through acid-catalyzed transacetalization-elimination process such as reported by Agarwal (2010), Tardy et al. (2017), and Psenti et al. (2020). Moreover, a preferred preparation method starts from commercially available saccharides (such as D-glucose pentaacetate, D-mannose pentaacetate, and D-galactose pentaacetate) via anomeric bromination followed by nucleophilic attack by the neighboring 2-O-acetate group and subsequent deprotonation. The two-step synthesis is readily scalable under mild conditions with high yields.

Homopolymerization is typically achieved by a free radical polymerization of a saccharide-CKA initiated by a free radical initiator such as azobisisobutyronitrile (AIBN), 2,2′-azobis-(2,4-dimethylvaleronitrile), and a peroxide compound (e.g., benzoyl peroxide (BPO) and di-t-butyl peroxide (DTBP)). A typical polymerization reaction is performed in a solvent such as benzene at a temperature in the range of 35-165° C. (e.g., 40-150° C., 45-135° C., 50-120° C., 60-110° C., 70-100° C., 75° C., 80° C., and 90° C.) for 1 hour to 100 hours (e.g., 2-50 hours, 4-45 hours, 6-40 hours, 8-32 hours, 12 hours, 18 hours, 24 hours, and 28 hours).

The completion of the reaction can be monitored by conventional methods such as HPLC and NMR. The product is optionally purified by an appropriate method useful for separate polymers such as washing with solvents, filtration, centrifuge, and the like.

The polymers thus prepared can be readily evaluated using known analytical technologies, e.g., ¹H and ¹³C NMR spectra. Through these analyses, the exemplary homopolymer of P(Glu-CKA) was found that the C2-O bond of Glu-CKA was quantitatively cleaved and a new C—C bond was formed at C2 for connecting to a neighboring repeat unit. Undesirable ring-retaining byproducts can also be detected by ¹H and ¹³C NMR spectra. The method of this invention generates insignificant amount of the ring-retaining byproducts that most likely not detectable in the homopolymerization of the saccharide-CKAs through the method as described above.

Polymers of this invention can also be prepared from copolymerization of saccharide-CKAs and vinyl monomers (e.g., acrylates and acrylamides). A third monomer is added in some embodiments. Preferred third monomers are maleimides such as N-phenyl maleimide.

Certain terminology is used in the following description for convenience only and is not limiting.

A range expressed as being between two numerical values, one as a low endpoint and the other as a high endpoint, includes the values between the numerical values and the low and high endpoints. Embodiments herein include subranges of a range herein, where the subrange includes a low and high endpoint of the subrange selected from any increment within the range selected from each single increment of the smallest significant figure, with the condition that the high endpoint of the subrange is higher than the low endpoint of the subrange.

Further embodiments herein include replacing one or more “including” or “comprising” in an embodiment with “consisting essentially of” or “consisting of.” “Including” and “comprising,” as used herein, are open ended, include the elements recited, and do not exclude the addition of one or more other elements. “Consisting essentially of” means that addition of one or more element compared to what is recited is within the scope, but the addition does not materially affect the basic and novel characteristics of the combination of explicitly recited elements. “Consisting of” refers to the recited elements, but excludes any element, step, or ingredient not specified.

The words “a” and “one,” as used in the claims and in the corresponding portions of the specification, are defined as including one or more of the referenced items unless specifically stated otherwise. This terminology includes the words above specifically mentioned, derivatives thereof, and words of similar import. The phrase “at least one” followed by a list of two or more items, such as “A, B, or C” or “A, B, and C” means any individual one of A, B or C as well as any combination thereof.

The term “axial” refers to a substituent on a pyranose or similar ring that point perpendicular to the plane of the ring. The term “equatorial” refers to a substituent that lie in the plane of the ring.

The term “alkyl” as used herein, means a straight or branched chain, monovalent or divalent hydrocarbon. An alkyl group herein may have from 1 to 30 carbon atoms (e.g., 1-25, 2-20, 3-16, 5-8, 1-6, and 1-4) unless otherwise specified. An alkyl group may have 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 carbon atoms, or a number of carbon atoms in a range from a first of the foregoing values to a second of the foregoing values, where the first and second values selected are any two of the foregoing values and the first value is less than the second. Examples include methyl (Me), methylene, ethyl, ethylene, n-propyl, i-propyl, n-butyl, i-butyl, and t-butyl.

The term “acetyl” refers to CH₃C(O)— or —CR₁R₂C(O)—, each of R₁ and R₂, independently, being H, halo, C₁-C₂₀ alkyl (e.g., C₁-C₃ alkyl such as methyl, ethyl, and propyl), C₂-C₂₀ alkenyl (e.g., vinyl), C₂-C₂₀ alkynyl, C₃-C₁₀ cycloalkyl, 3-20 membered heterocycloalkyl, aryl (e.g., phenyl), or heteroaryl. The term “acetal” refers to a functional group represented by

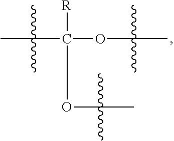

in which R is H, C₁-C₂₀ alkyl (e.g., C₁-C₃ alkyl such as methyl, ethyl, and propyl), C₂-C₂₀ alkenyl (e.g., vinyl), C₂-C₂₀ alkynyl, C₃-C₁₀ cycloalkyl, 3-20 membered heterocycloalkyl, aryl (e.g., phenyl), or heteroaryl. The term “ketene acetal” refers to

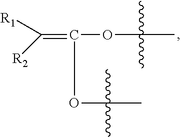

R₁ and R₂ as defined above. A cyclic ketene acetal has a ring formed from the two ether functional groups (—O—) and the atoms (e.g, carbon) to which they are bonded.

The term “alkenyl” refers to a linear or branched monovalent or divalent hydrocarbon moiety that contains at least one double bond.

The term “alkynyl” refers to a linear or branched monovalent or divalent hydrocarbon moiety that contains at least one triple bond.

The term “cycloalkyl” refers to a saturated or unsaturated, cyclic, nonaromatic, monovalent or divalent hydrocarbon moiety, such as cyclohexyl and cyclohexylene.

The term “heterocycloalkyl” refers to a nonaromatic 5-8 membered monocyclic, 8-12 membered bicyclic, or 11-14 membered tricyclic, monovalent or divalent ring system having one or more heteroatoms (e.g., O, N, P, and S). Examples include aziridinyl, azetidinyl, pyrrolidinyl, dihydrofuranyl, tetrahydrofuranyl, tetrahydropyranyl, tetrahydrothiophenyl, tetrahydro-2-H-thiopyran-1,1-dioxidyl, piperazinyl, piperidinyl, morpholinyl, imidazolidinyl, azepanyl, dihydrothiadiazolyl, dioxanyl, and quinuclidinyl. Both “cycloalkyl” and “heterocyclyl” also include fused, bridged, and spiro ring systems. They further include substituted groups such as halocycloalkyl and haloheterocyclyl.

The term “aryl” herein refers to a monocyclic, bicyclic or tricyclic aromatic, monovalent or divalent ring system. Examples include phenyl, biphenyl, 1- or 2-naphthyl, 1,2-dihydronaphthyl, 1,2,3,4-tetrahydronaphthyl, indenyl, and indanyl. Aryl can be unsubstituted or substituted with alkyl, alkenyl, alkynyl, cycloalkyl, heterocycloalkyl, aryl, heteroaryl, amino, ether, ester, and the like. The term “aralkyl” refers to alkyl substituted with aryl, i.e., aryl-alkyl.

The term “heteroaryl” herein refers to an aromatic monocyclic, bicyclic, tricyclic, and tetracyclic ring system having one or more heteroatoms (such as O, S or N). Examples include pyridinyl, pyrimidinyl, quinolinyl, isoquinolinyl, indolyl, benzimidazolyl, benzoxazolyl, benzothiophenyl, benzofuranyl, pyrazolyl, triazolyl, oxazolyl, thiadiazolyl, tetrazolyl, oxazolyl, isoxazolyl, carbazolyl, furyl, imidazolyl, thienyl, thiazolyl, and benzothiazolyl. The term “heteroaralkyl” refers to alkyl substituted with heteroaryl, i.e., heteroaryl-alkyl.

The term “monosaccharide” refers to a sugar having a five- or six-membered carbon backbone (i.e., a hexose). Monosaccharides also include hexoses substituted with hydroxy groups, oxo groups, amino groups, acetamido groups, and other functional groups. Monosaccharides further include deoxy monosaccharides having one or more carbon atoms in the hexose backbone having only hydrogen substituents. Examples of monosaccharides include, but are not limited to, glucose (Glu), galactose (Gal), mannose (Man), glucuronic acid (GlcA), iduronic acid (IdoA), allose, altrose, arabinose, cladinose, erythrose, erythrulose, fructose, D-fucitol, L-fucitol, fucosamine, fucose, foculose, D-galactosaminitol, glucosaminitol, glucose-6-phosphate, gulose glyceraldehyde, L-glycero-D-mannos-heptose, glycerol, glycerone, gulose, idose, lyxose, mannosamine, mannose-6-phosphate, psicose, quinovose, quinovosamine, rhamnitol, rhamnosamine, rhamnose, ribose, ribulose, sedoheptulose, sorbose, tagatose, talose, tartaric acid, threose, xylose, xylulose, glucosamine (2-amino-2-deoxy-glucose; GlcN), N-acetylglucosamine (2-acetamido-2-deoxy-glucose; GlcNAc), galactosamine (2-amino-2-deoxy-galactose; GalN), N-acetylgalactosamine (2-acetamido-2-deoxy-galactose; GalNAc), mannosamine (2-amino-2-deoxy-mannose; ManN), and N-acetylmannosamine (2-acetamido-2-deoxy-mannose; ManNAc).

The monosaccharide can be in D- or L configuration. The monosaccharide may further be an amino sugar (alcoholic hydroxy group replaced by amino group), a thio sugar (alcoholic hydroxy group replaced by thiol, or C═O replaced by C═S, or a ring oxygen of cyclic form replaced by sulfur), a seleno sugar, a telluro sugar, an aza sugar (ring carbon replaced by nitrogen), an imino sugar (ring oxygen replaced by nitrogen), a phosphano sugar (ring oxygen replaced with phosphorus), a phospha sugar (ring carbon replaced with phosphorus), a C-substituted monosaccharide (hydrogen at a non-terminal carbon atom replaced with carbon), an unsaturated monosaccharide, an alditol (carbonyl group replaced with CHOH group), aldonic acid (aldehydic group replaced by carboxy group), a ketoaldonic acid, a uronic add, an aldaric acid, and so forth. Amino sugars include amino monosaccharides. In some embodiments, an amino monosaccharide is mannosamine, fucosamine, quinovosamine, neuraminic acid, muramic acid, lactosediamine, acosamine, bacillosamine, daunosamine, desosamine, forosamine, garosamine, kanosamine, kansosamine, mycaminose, mycosamine, perosamine, pneumosamine, purpurosamine, or rhodosamine. It is understood that the monosaccharide and the like can be further substituted.

The term “oligosaccharide” refers to a compound containing at least two monosaccharides covalently linked together. Oligosaccharides include disaccharides (two monosaccharides), trisaccharides, tetrasaccharides, pentasaccharides, hexasaccharides, heptasaccharides, octasaccharides, and the like. Covalent linkages for linking sugars generally consist of glycosidic linkages (i.e., C—O—C bonds) formed from the hydroxyl groups of adjacent sugars. Linkages can occur between the 1-carbon (the anomeric carbon) and the 4-carbon of adjacent sugars (i.e., a 1-4 linkage), the 1-carbon (the anomeric carbon) and the 3-carbon of adjacent sugars (i.e., a 1-3 linkage), the 1-carbon (the anomeric carbon) and the 6-carbon of adjacent sugars (i.e., a 1-6 linkage), or the 1-carbon (the anomeric carbon) and the 2-carbon of adjacent sugars (i.e., a 1-2 linkage). A sugar can be linked within an oligosaccharide such that the anomeric carbon is in the α- or β-configuration. Examples include abequose, acrabose, anucetose, amylopectin, amylose, apiose, arcanose, ascarylose, ascorbic acid, boivinose, cellobiose, cellobiose, cellulose, chacotriose, chalcose, chitin, colitose, cyclodextrin, cymarose, dextrin, 2-deoxyribose, 2deoxyglucose, diginose, digitalose, digitoxose, evalose, evemitrose, fructooligosaccharides, galto-oligosaccharide, gentianose, gentiobiose, glucan, glucogen, glycogen, hamamelose, heparin, inulin, isolevoglucosenone, isomaltose, isomaltotriose, isopanose, kojibiose, lactose, lactosamine, lactosediamine, laminaribiose, levoglucosan, levoglucosenone, P-maltose, maltriose, mannan-oligosaccharide, manninotnose, melezitose, melibiose, muramic acid, mycarose, mycinose, neuraminic acid, nigerose, nojirimycin, noviose, oleandrose, panose, paratose, planteose, pnmeverose, raffinose, rhodinose, rutinose, sarmentose, sedoheptulose, sedoheptulosan, solatriose, sophorose, stachyose, streptose, sucrose, am-trehalose, trehalosamine, turanose, tyvelose, xylobiose, umbelliferose and the like. Further, it is understood that the “disaccharide”, “trisaccharide” and “polysaccharide” and the like can be further substituted. They also include amino sugars and their derivatives, e.g., mycaminose.

As used herein, the term “isomer” refers to a compound having the same bond structure as a reference compound but having a different three-dimensional arrangement of the bonds. An isomer can be, for example, an enantiomer or a diastereomer.

The term “amino” refers to primary (NH₂), secondary (—NH—), tertiary

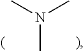

or quaternary

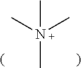

amine group bonding to or being included in one or more of C₁-C₃₀ (e.g., C₂-C₂₀ and C₄-C₁₆) alkyl, C₁-C₃₀ (e.g., C₂-C₂₀ and C₄-C₁₆) heteroalkyl, aryl, or heteroaryl moieties. Examples include alkyl amino, dialkyl amino, alkenyl amino, etc. Aliphatic amino examples include C₁-C₃₀ alkyl amino, C₂-C₃₀ alkenyl amino, C₂-C₃₀ alkynyl amino, and C₃-C₃₀ cycloalkyl, C₁-C₃₀ heterocycloalkyl amino is an example of heteroaliphatic amino.

The term “ketone” refers to R—C(O)—R″, in which each of R and R″, independently, is (e.g., C₂-C₂₀ and C₄-C₁₆) alkyl, C₁-C₃₀ (e.g., C₂-C₂₀ and C₄-C₁₆) heteroalkyl, aryl, or heteroaryl.

The term “carbonyl” refers to —C(O)—R″, in which R″ is defined above.

The term “carboxylate” refers to —O—C(O)—R″ or —C(O)—O—R″, in which R″ is define above.

The term “halo” refers to H, F, Cl, Br, or I.

The term “heteroatom” refers to an atom that is not C or H, such as O, N, S, and P.

Alkyl, heteroalkyl, alkenyl, alkynyl, cycloalkyl, amino, carbonyl, carboxylate, carbamate, aryl, aralkyl, sulfonic, and phosphoric mentioned herein include both substituted and unsubstituted moieties, unless specified otherwise. Examples of a substituent include deuterium (D), hydroxyl (OH), halo (e.g., F and Cl), amino (NH₂), cyano (CN), nitro (NO₂), alkyl, alkenyl, alkynyl, alkoxy, cycloalkyl, acylamino, alkylamino, aminoalkyl, haloalkyl (e.g., trifluoromethyl), heterocyclyl, alkoxycarbonyl, amido, carboxyl (COOH), alkanesulfonyl, alkylcarbonyl, alkenylcarbonyl, carbamido, carbamyl, carboxyl, thioureido, thiocyanato, sulfonamido, aryl, arylamino, aralkyl, and heteroaryl. All substitutes can be further substituted.

The term “RAFT reagent” refers to a chemical useful for reversible addition-fragmentation chain-transfer polymerization to afford control of the molecular weight and polydispersity of a polymer as prepared during a free-radical polymerization.

Without further elaboration, it is believed that one skilled in the art can, based on the above description, utilize the present invention to its fullest extent. The following specific examples are, therefore, to be construed as merely illustrative, and not limitative of the remainder of the disclosure in any way whatsoever.

All publications, including patent documents, cited herein are incorporated by reference in their entirety.

### EXAMPLES

Exemplary polymers were prepared and evaluated as described below. All manipulations of air- and moisture-sensitive materials were carried out under nitrogen in a glovebox or by using standard Schlenk line techniques. Solvent for polymerization, anhydrous benzene, was purchased from Sigma-Aldrich (catalog No. 401765, St Louis, MO) and stored in a nitrogen gas-filled glovebox. Other solvents (acetone, toluene, EtOAc, MeOH, Et₂O) were used as received. Chemicals were purchased from Alfa Aesar (Haverhill, MA), Sigma-Aldrich, Fisher Scientific (Waltham, MA), Oakwood Chemical (Estill, SC), or Strem Chemicals (Newburyport, MA) and used as received without further purification. Concentrations unless otherwise indicated refer to solution volumes at 22° C. Evaporation and concentration in vacuo were performed using house vacuum (ca. 40 mm Hg). Column chromatography was performed with SiliaFlash® 60 (40-63 micron) silica gel from Silicycle Inc. (Quebec City, Canada).

Nuclear magnetic resonance (NMR) spectra were obtained including ¹H, ¹³C, COSY, HSQC, NOESY, DOSY NMR. Spectra were recorded on 600 MHz Varian®/Agilent® NMR spectrometer or 500 MHz VNMRS Varian®/Agilent® NMR spectrometer or 500 MHz Bruker® Prodigy system or 500 MHz Bruker® system with a helium CryoProbe™ and autosampler at the Boston College nuclear magnetic resonance facility. Chemical shifts for protons are reported in parts per million downfield from tetramethylsilane and are referenced to residual protium in the NMR solvent. Chemical shifts for carbon are reported in parts per million downfield from tetramethylsilane and are referenced to the carbon resonances of the solvent. The solvent peak was referenced to 0 ppm for 1H for tetramethylsilane and 77.0 ppm for ¹³C for CDCl₃. Data are represented as follows: chemical shift, integration, multiplicity (br=broad, s=singlet, d=doublet, t=triplet, q=quartet, qn=quintet, sp=septet, m=multiplet), coupling constants in Hertz (Hz).

High-Resolution Mass Spectrometry—High-resolution mass spectrometry was performed on a JEOL® AccuTOF™-DART™ (positive mode) or Agilent® 6220 TOF-ESI (positive mode) at the Mass Spectrometry Facility, Boston College.

Size-exclusion chromatography (SEC)—Analyses were carried out using a Tosoh's high performance SEC system HLC®-8420GPC with a refractive index detector and WYATT® miniDAWN® MALS detector or a Tosoh's high performance SEC system HLC®-8320GPC with a refractive index detector. The Tosoh HLC®-8420GPC SEC system was equipped with two TSKgel® GMH_{HR}-N columns (5 μm, 7.8 mm I.D.×30 cm), which were eluted with CHCl₃ at 40° C. at a rate of 0.5 mL/min and calibrated using polystyrene standards (ReadyCal® Kit, Sigma-Aldrich #81434). The Tosoh HLC®-8320GPC SEC system was equipped with three TSKgel® a-M columns (13 μm, 7.8 mm I.D.×30 cm), which were eluted with DMF at 50° C. at a rate of 0.5 mL/min and calibrated using polystyrene standards (ReadyCal® Kit, Sigma-Aldrich #81434).

A facile procedure developed by Tosoh Bioscience described as follows was used to measure the specific refractive index dn/dc, which requires a standard with known dn/dc and a solution of the analyte. First, a polystyrene standard solution in CHCl₃ with the concentration Cᵢₙⱼ of 1.08 mg/mL was run through SEC system with the injection volume Vᵢₙⱼ of 100 μL. The integrated area RIₐᵣₑₐ was calculated as 7498.275 mV·sec, and the dn/dc of polystyrene in CHCl₃ at 40° C. is 0.161 mL/g. Thus, the RI constant KRI for the system was calculated to be 431.233 based on the following equation.

KRI=RIₐᵣₑₐ/(Cᵢₙⱼ·Vᵢₙⱼ·dn/dc)

For the measurement of dn/dc of polymer, the analyte solution was run through the SEC system with the injection volume Vᵢₙⱼ from 20 μL to 100 μL with the interval of 20 μL. Thus, SEC elution profiles of polymer with different injection volumes were obtained and a plot of RIₐᵣₑₐ/(KRI·Cᵢₙⱼ) to Vᵢₙⱼ was made, and the slope of the plot is the dn/dc value. Using this method, the dn/dc values of P(Glu-CKA), P(Man-CKA), P(Gal-CKA) were measured as 0.0343 mL/g, 0.0278 mL/g and 0.0371 mL/g, respectively.

Thermogravimetric Analysis (TGA)—Thermal gravimetric analysis was obtained using Netzsch® Instruments STA 449 F1 Jupiter®. Analysis was performed on ˜10 mg of a given sample at a heating rate of 10° C./min from 35 to 500° C. under nitrogen and argon gas.

Differential Scanning calorimetry (DSC)—Data was recorded on Netzsch® instruments DSC 214 Polyma® using 5-20 mg samples. All T_{g} values were obtained from a second scan after the thermal history was removed from the first scan. The second heating rate was 10° C./min and cooling rate was 10° C./min.

Abbreviations Used—AgClO₄=Silver perchlorate, AIBN=Azobisisobutyronitrile, CDCl₃=Deuterated chloroform, CHCl₃=Chloroform, CH₂Cl₂=Methylene chloride, C₆D₆=Deuterated benzene, DMA=N,N-Dimethylacrylamide, DMF=Dimethylformamide, Et₂O=diethyl ether HBr=Hydrobromic acid, MA=Methyl acrylate, MeOH=Methanol, MeONa=Sodium methoxide, MMA=Methyl methacrylate, Na₂SO₄=Sodium sulfate, PTLC=preparation thin layer chromatography, rt=Room temperature, TFA=trifluoroacetic acid.

### Saccharide-CKA Monomers

Saccharide-CKA Monomers were synthesized according to Scheme I below.

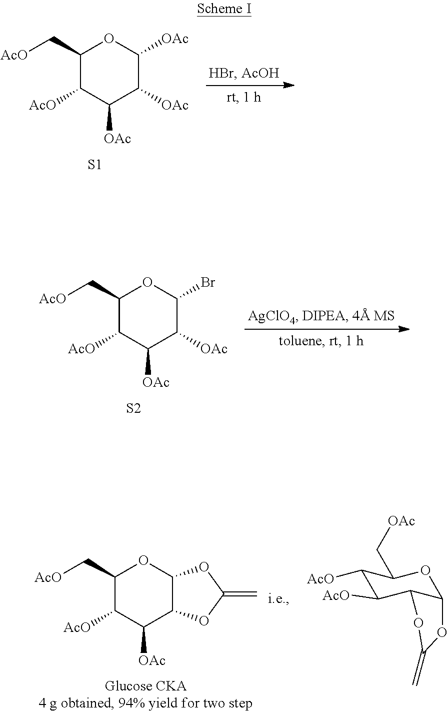

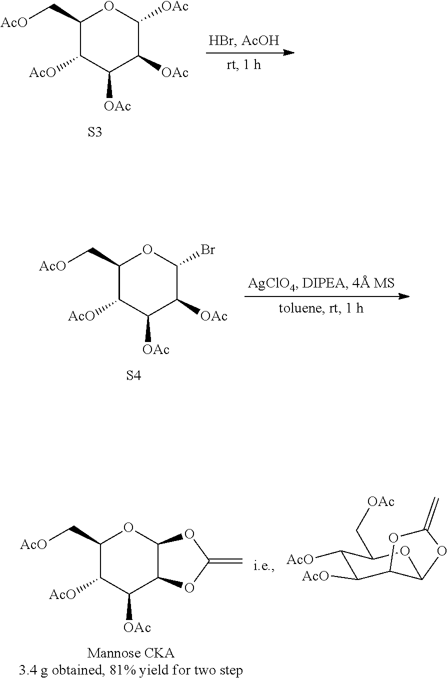

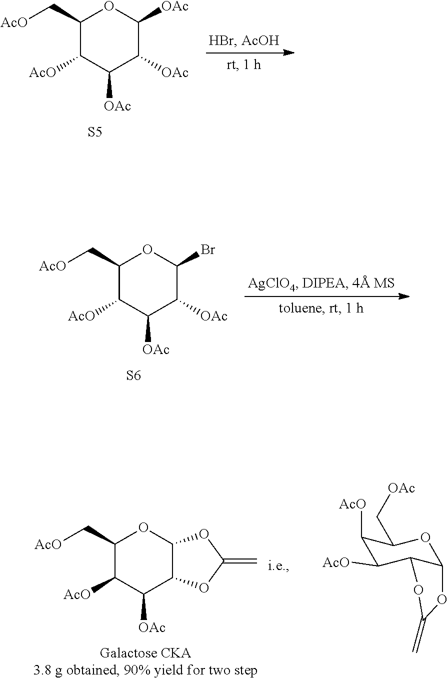

General Procedure for Monosaccharide CKAs Synthesis—Monosaccharide CKA monomers were synthesized as follows. To a dry 100 mL round bottom flask, pentaacetate glucose (S1, 5 g, 12.8 mmol) and stir bar were added. Then 15 mL 33% HBr solution in acetic acid was added slowly. The resulting mixture was allowed to stir at room temperature for 1 hour. After 1 hour, ¹H NMR of the crude reaction mixture was performed to assure the full conversion of the starting material. The reaction mixture was diluted by 200 mL Et₂O and washed by 200 mL water 5 times to remove excess HBr and acetic acid. Next, the organic layer was separated, dried over anhydrous Na₂SO₄, and concentrated by rotary evaporation to give S2 as a white solid in quantitative yield.

To a 500 mL round bottom three neck flask, 30 g 4 Å molecular sieves (powder) and stir bar were added. Under vacuum, the flask was flame-dried for 20 minutes and cooled to room temperature under vacuum. Under the nitrogen protection, all S2 from last step, diisopropyl ethyl amine (7.8 mL, 3.5 eq), and 350 mL dry toluene were added, and reaction mixture was allowed to stir for 5 minutes. Next, under nitrogen protection, AgClO₄ (3.98 g, 1.5 eq) was added in one portion. The reaction flask was covered by aluminum foil to protect from light, and the mixture was vigorously stirred in dark at room temperature for 1 hour. After 1 hour, ¹H NMR of the crude reaction mixture was performed to ensure full conversion of the starting material. The reaction mixture was subsequently filtered with celite to remove excess silver salt, washed with 200 mL water twice to remove the remaining sliver salt, and dried over anhydrous Na₂SO₄, concentrated using rotary evaporation to give Glu-CKA as a pale yellow sticky liquid, which can be directly used for polymerization (4 g, 94% yield for two steps). For storage and use, all monosaccharide CKAs are dissolved in anhydrous benzene to prepare 1 M stock solution and stored in glove box freezer (−40° C.). With this storage method, no NMR detectable decomposition after two months.

Glu-CKA: ¹H NMR (500 MHz, CDCl₃) δ 5.80 (d, J=5.3 Hz, 1H), 5.25 (t, J=3.7 Hz, 1H), 4.96 (dd, J=9.6, 3.7 Hz, 1H), 4.43 (t, J=4.4 Hz, 1H), 4.28-4.17 (m, 2H), 4.00-3.93 (m, 1H), 3.46 (d, J=3.5 Hz, 1H), 3.40 (d, J=3.5 Hz, 1H), 2.12 (s, 3H), 2.10 (s, 3H), 2.09 (s, 3H); ¹³C NMR (126 MHz, CDCl₃) δ 170.6, 169.6, 169.2, 161.9, 96.8, 74.0, 69.8, 68.4, 67.4, 62.5, 56.5, 20.7; HRMS (DART) m/z Calcd for C₁₄H₁₉O₉ [M+H⁺]: 331.10236; found: 331.10270.

Following same procedure as described above except that pentaacetate mannose was used, Man-CKA was obtained as a white solid (3.4 g, 81% yield for two steps), which was directly used for polymerization. Optionally, it was purified by recrystallization with ethyl acetate/hexanes or benzene. ¹H NMR (500 MHZ, CDCl₃) δ 5.65 (d, J=3.4 Hz, 1H), 5.33-5.24 (m, 1H), 5.24-5.17 (m, 1H), 4.64 (t, J=3.6 Hz, 1H), 4.27-4.16 (m, 2H), 3.86-3.81 (m, 1H), 3.56-3.48 (m, 2H), 2.14 (s, 3H), 2.08 (s, 3H), 2.07 (s, 3H). ¹³C NMR (126 MHz, CDCl₃) δ 170.6, 170.2, 169.3, 161.9, 96.4, 76.1, 72.4, 69.6, 65.4, 62.7, 58.3, 20.7, 20.6, 20.6. HRMS (DART) m/z Calcd for C₁₄H₁₉O₉ [M+H⁺]: 331.10236; found: 331.10285.

Gal-CKA was obtained with a similar procedure as a pale red sticky liquid (3.8 g, 90% yield for two steps). For second step, 2.5 equiv. AgClO₄ and 7 equiv. diisopropyl ethyl amine was used, and reaction was stirred in room temperature for 2 h. ¹H NMR (500 MHZ, CDCl₃) δ 5.84 (d, J=5.0 Hz, 1H), 5.47-5.40 (m, 1H), 5.04 (dd, J=7.7, 3.3 Hz, 1H), 4.40-4.31 (m, 2H), 4.20-4.10 (m, 2H), 3.51-3.40 (m, 2H), 2.14 (s, 3H), 2.08 (s, 3H), 2.07 (s, 3H). ¹³C NMR (126 MHz, CDCl₃) δ 170.4, 169.9, 169.8, 160.0, 98.5, 71.9, 69.8, 69.1, 65.7, 61.4, 58.6, 20.7, 20.7, 20.6. HRMS (DART) m/z Calcd for C₁₄H₁₉O₉ [M+H⁺]: 331.10236; found: 331.10292.

### Polymerization

General Procedure of Homopolymerization—To a flame-dried 100 mL round bottom flask, stir bar, monosaccharide CKA (1.98 g, 6 mmol), AIBN (19.7 mg, 0.12 mmol), and anhydrous benzene (30 mL) was added in glove box under nitrogen atmosphere. Then, the flask was capped with rubber stopper and sealed with tape in the glove box. Next, the flask was transferred out of the glove box, heated to 80° C., and stirred for 24 hours. After the reaction was finished by checking the crude ¹H NMR, reaction mixture was cooled to room temperature and diluted by 50 mL methylene chloride. The methylene chloride solution was then added dropwise into 500 mL diethyl ether under vigorous stirring in a 1000 mL round bottom flask to result in a cloudy suspension. The crude polymer was collected by vacuum filtration. The crude polymer was then dissolved in 30 mL methylene chloride and the precipitation process was repeated two more times. The resulting polymer was dried under high vacuum overnight to a constant weight, before being subjected to NMR analyses in CDCl₃ and SEC analysis in CHCl₃ solvent.

General Procedure of Copolymerization—To an oven-dried 8 mL culture tube, monomers, AIBN, anhydrous benzene, and a stir bar were added in the glove box under nitrogen atmosphere. The culture tube was capped, sealed with tape, and transferred out of the glove box. Then, the reaction mixture was allowed to stir in the oil bath preheated to 80° C. for 1 hour. After reaction finished, the tube was cooled to room temperature. The crude polymer was dissolved in 5 mL CHCl₃ and then precipitated into diethyl ether, centrifuged, discarded the solvent, and redissolve in methylene chloride. This procedure was repeated three times to ensure any catalyst residue or unreacted monomer was removed. The polymer was dried under high vacuum overnight to a constant weight. The resulting polymer was analyzed by NMR, SEC, TGA and DSC. The composition of the copolymer was determined by integration of peaks in ¹H NMR.

### Example 1: Poly(GLU-CKA)

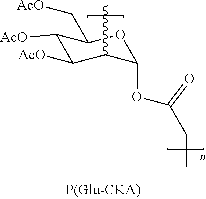

P(Glu-CKA) (1.2 g, 61% yield white solid) was obtained from Glu-CKA (1.98 g, 6 mmol) with General Procedure of Homopolymerization. Crude ¹H NMR shows 69% conversion. ¹H NMR (500 MHZ, CDCl₃) δ 6.46-6.07 (m, 1H), 5.57-5.37 (m, 1H), 5.29-5.05 (m, 1H), 4.32-3.99 (m, 3H), 2.99-2.37 (m, 3H), 2.13-2.01 (m, 9H). ¹³C NMR (126 MHZ, CDCl₃) δ 170.5, 169.7, 169.5, 169.3, 93.2, 70.5, 68.7, 65.5, 61.9, 38.3, 29.9, 20.8, 20.7, 20.6. SEC (CHCl₃) M_{n, MALS}=21.0 kDa, Ð=1.58, dn/dc=0.0343 mL/g; M_{n, RI}=10.7 kDa, Ð=2.00. DSC T_{g}=104° C. TGA T_{d}=228° C.

### Example 2: Poly(Man-CKA)

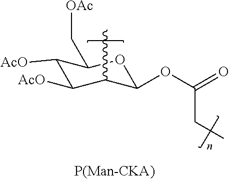

P(Man-CKA) (1.14 g, 58% yield white solid) was obtained from Man-CKA (1.98 g, 6 mmol) with General Procedure of Homopolymerization. Crude ¹H NMR shows 66% conversion. ¹H NMR (500 MHZ, CDCl₃) δ 6.11-5.37 (m, 1H), 5.36-4.92 (m, 2H), 4.59-4.19 (m, 1H), 4.19-3.95 (m, 1H), 3.95-3.58 (m, 1H), 3.21-2.16 (m, 3H), 2.15-1.92 (m, 9H). ¹³C NMR (126 MHZ, CDCl₃) δ 170.6, 170.2, 169.7, 169.1, 93.6, 72.5, 68.9, 65.6, 61.9, 41.2, 31.2, 20.7. SEC (CHCl₃) M_{n, MALS}=16.7 kDa, Ð=1.63, dn/dc=0.0278 mL/g; M_{n, RI}=5.8 kDa, Ð=1.59. DSC T_{g}=102° C. TGA T_{d}=225° C.

### Example 3: Poly(Gal-CKA)

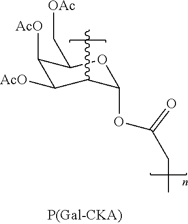

P(Gal-CKA) (0.8 g, 40% yield yellow solid) was obtained from Gal-CKA (1.98 g, 6 mmol) with General Procedure of Homopolymerization. Crude ¹H NMR shows 71% conversion. ¹H NMR (500 MHZ, CDCl₃) δ 6.47-5.66 (m, 1H), 5.61-4.98 (m, 2H), 4.46-3.89 (m, 3H), 3.01-2.29 (m, 3H), 2.29-1.94 (m, 9H). ¹³C NMR (126 MHz, CDCl₃) δ 170.3, 170.0, 169.8, 169.6, 93.9, 92.8, 68.5, 65.8, 65.3, 61.3, 36.2, 30.9, 20.9, 20.7, 20.5. SEC (CHCl₃) M_{n, MALS}=11.8 kDa, Ð=1.38, dn/dc=0.0371 mL/g; M_{n, RI}=5.8 kDa, Ð=1.38. DSC T_{g}=72° C. TGA T_{d}=220° C.

### Example 4: Copolymer 1 (coP1)

Copolymer 1 (coP1) was synthesized with 1 M stock solution of Glu-CKA in benzene (0.4 mL, 0.4 mmol), MI (138.5 mg, 0.8 mmol), MMA (200.2 mg, 213.2 μL, 2 mmol) and AIBN (1.31 mg, 8 μmol) using the General Procedure of Copolymerization (334.5 mg, 71% yield), which was analyzed by NMR, SEC, TGA and DSC. The incorporation molar ratio of each monomer in the copolymer was determined to be Glu-CKA: MI: MMA=1:3.1:9.3 as calculated from NMR peaks, namely 6.27-3.90 (br, 6H) for Glu-CKA, 7.44 (s) for MI, and 3.60 (s) for MMA. ¹H NMR (500 MHz, CDCl₃) δ 7.55-7.32 (br, 9H), 7.26-7.10 (br, 6H), 6.27-3.90 (br, 6H), 3.89-3.24 (br, 28H), 3.10-0.70 (br, 62H). Certain NMR peaks were combined to simplify reporting of the data. SEC (DMF) M_{n, RI}=70.3 kDa, Ð=2.34. DSC T_{g}=153° C. TGA T_{d}=294° C.

### Example 5: Copolymer 2 (coP2)

Copolymer 2 (coP2, 342 mg, 92% yield)) was synthesized with 1 M stock solution of Glu-CKA in benzene (0.2 mL, 0.2 mmol), MI (103.9 mg, 0.6 mmol), MMA (200.2 mg, 213.2 μL, 2 mmol), and AIBN (1.31 mg, 8 μmol) using the General Procedure of Copolymerization, which was analyzed by NMR, SEC, TGA and DSC. The ratio of each of each monomer in the copolymer was determined to be Glu-CKA: MI: MMA=1:4.4:15.2 using NMR peaks, namely, 6.42-3.88 (br) for Glu-CKA, 7.44 (s) for MI, and 3.61 (s) for MMA. ¹H NMR (500 MHz, CDCl₃) δ 7.58-7.32 (br, 13H), 7.26-7.11 (br, 9H), 6.42-3.88 (br, 6H), 3.87-3.32 (br, 46H), 3.28-0.62 (br, 95H). Certain NMR peaks were combined to simplify reporting of the data. SEC (DMF) M_{n, RI}=81.4 kDa, Ð=2.59. DSC T_{g}=144° C. TGA T_{d}=253° C.

### Example 6: Copolymer 4 (coP4)

Copolymer 4 (coP4) was synthesized with 1 M stock solution of Glu-CKA in benzene (0.2 mL, 0.2 mmol), MI (103.9 mg, 0.6 mmol), MA (172.2 mg, 180.1 μL, 2 mmol), and AIBN (1.31 mg, 8 μmol) using the General Procedure of Copolymerization (325 mg, 95% yield), which was analyzed by NMR, SEC, TGA and DSC. The ratio of each monomer in the copolymer was determined to be Glu-CKA:MI:MA=1:3.3:10.7 using NMR peaks, namely 6.22-4.98 (br) for Glu-CKA, 7.44 (s) for MI, and 3.62 (s) for MA. ¹H NMR (500 MHZ, CDCl₃) δ 7.52-7.33 (br, 10H), 7.29-7.18 (br, 7H), 6.22-3.89 (br, 6H), 3.88-3.46 (br, 32H), 3.46-1.18 (br, 50H). SEC (DMF) M_{n, RI}=74.7 kDa, f)=3.17. DSC T_{g}=96° C. TGA T_{d}=322° C.

### Example 7: Copolymer 5 (coP5)

Copolymer 5 (coP5) was synthesized with 1 M stock solution of Glu-CKA in benzene (0.2 mL, 0.2 mmol), MI (103.9 mg, 0.6 mmol), DMA (198.3 mg, 206.1 μL, 2 mmol), and AIBN (1.31 mg, 8 μmol) using the General Procedure of Copolymerization (324 mg, 88% yield), which was analyzed by NMR, SEC, TGA and DSC. The ratio of each monomer in the copolymer was determined to be Glu-CKA: MI: DMA=1:4.3:12.6 using NHR peaks, namely, 6.40-3.80 (br) for Glu-CKA, 7.42 (s) for MI, and 2.92 (s) for DMA. ¹H NMR (500 MHZ, CDCl₃) δ 7.49-7.30 (br, 13H), 7.27-7.00 (br, 8H), 6.40-3.80 (br, 6H), 3.76-1.07 (br, 134H). SEC (DMF) M_{n, RI}=55.1 kDa, f)=2.73. DSC T_{g}=168° C. TGA T_{d}=281° C.

### General Procedure for Examples 8-12

To a 7-mL vial, monomers, AIBN (1.31 mg, 8 μmol) and C₆D₆ (0.4 mL) were added and shaken until fully dissolved. The resulting solution was transfer to an oven-dried NMR tube and sealed with a rubber NMR cap with tape. After ¹H NMR confirming the ratio of monomers in solution, the NMR tube was connected to Schlenk line by a needle and was subjected to freeze-pump-thaw degassing three times with nitrogen under −78° C. The NMR spectrometer was pre-equilibrated pre-shimmed at 80° C. before the injection of the sample. Continuous ¹H NMR analyses of the reaction were performed at 80° C. to monitor the conversion vs time.

### Example 8: Copolymer of Glu-CKA and Methyl Methacrylate (MMA)

Copolymerization was performed with Glu-CKA (66.1 mg, 0.2 mmol) and MMA (20 mg, 21.3 μL, 0.2 mmol) at the 1:1 feed ratio using the General Procedure for EXAMPLES 8-12. The NMR results showed that both Glu-CKA and MMA were successfully incorporated into copolymer of Glu-CKA and MMA. Nevertheless, the conversion rate of Glu-CKA was lower than MMA, indicating that the copolymer has significant MMA segments.

### Example 9: Copolymer of Glu-CKA and N-Phenyl Maleimide (MI)

Copolymerization was performed with Glu-CKA (66.1 mg, 0.2 mmol) and MI (34.6 mg, 0.2 mmol) at the 1:1 feed ratio. The NMR results showed that both Glu-CKA and MI were successfully incorporated into copolymer of Glu-CKA and MI. The conversion rate of Glu-CKA was the same as that of MI, indicating that the copolymer has a 1:1 ratio of Glu-CKA and MI.

### Example 10: Copolymer of Glu-CKA, MI, and MMA at 1:1:1

Copolymerization was performed with Glu-CKA (66.1 mg, 0.2 mmol), MI (34.6 mg, 0.2 mmol), and MMA (20 mg, 21.3 μL, 0.2 mmol) at the 1:1:1 ratio. All three monomers showed similar conversion rates throughout the copolymerization reaction, indicating that the copolymer has 1:1:1 ratio of Glu-CKA, MI, and MMA. As compared to Example 8, the addition of MI improved the incorporation of Glu-CKA in the copolymerization with MMA.

### Example 11: Copolymer of Glu-CKA, MI, and MMA at 1:1:5

Copolymerization was performed with Glu-CKA (18.9 mg, 57.1 μmol), MI (9.9 mg, 57.1 μmol) and MMA (28.6 mg, 30.4 μL, 285.5 μmol) at the 1:1:5 ratio. The NMR results showed that monomers Glu-CKA, MI, and MMA were successfully incorporated into the copolymer. The conversion rate of Glu-CKA was lower than MI and MMA.

### Example 12: Copolymer of Glu-CKA, MI, and MMA at 1:2:5

Copolymerization was performed with Glu-CKA (16.5 mg, 50 μmol), MI (17.3 mg, 100 μmol), and MMA (25 mg, 26.6 μL, 250 μmol) at a ratio of 1:2:5. The NMR results demonstrated similar conversion rates for all three monomers throughout the entire reaction, producing a copolymer coP1 in 71% yield. As calculated from ¹H NMR data, the copolymer incorporated the three monomers at the ratio of 1:3.1:9.3 for Glu-CKA: MI: MMA.

### Comparative Copolymer

Comparative copolymer coP3 was synthesized with (173.2 mg, 1 mmol) MI, (500.6 mg, 533 μL, 5 mmol) MMA and (1.31 mg, 8 μmol) AIBN using the General Procedure of Copolymerization (476 mg, 71% yield), which was analyzed by NMR, SEC, TGA and DSC. The ratio of each monomer in the polymer was determined to be MI: MMA=1:5.4. ¹H NMR (500 MHz, CDCl₃) δ 7.57-7.32 (br, 3H), 7.26-7.10 (br, 2H), 3.85-3.41 (br, 16H), 3.07-1.67 (br, 13H), 1.67-0.72 (br, 18H). SEC (DMF) M_{n, RI}=158.8 kDa, Ð=3.95. DSC T_{g}=150° C. TGA T_{d}=347° C.

### Degradation of Homopolymers

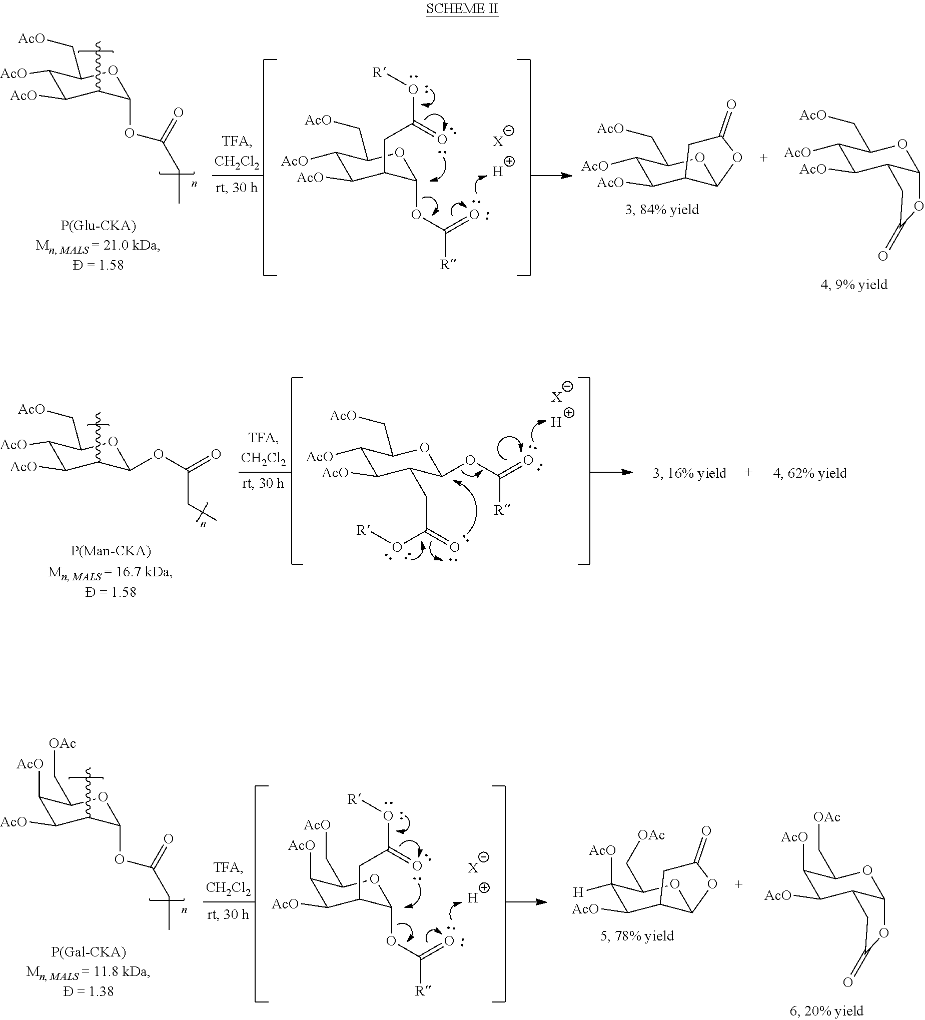

General Procedure of Acidic Degradation of Homopolymers—To a 7 mL vial, homopolymer (20 mg, 60 μmol of repeating units), 0.3 mL methylene chloride, and 0.3 mL trifluoroacetic acid added. The resulting mixture was allowed to stir at room temperature for 30 hours. Then the reaction mixture was concentrated by rotary evaporation. Next, mesitylene was added as internal standard and NMR yield was obtained from crude NMR. Different diastereomers were separated by PTLC.

Compound 3 was obtained in 84% NMR yield from P(Glu-CKA) and 16% NMR yield from P(Man-CKA) using the General Procedure of Acidic Degradation of Homopolymers, separated by PTLC with Hex: EA=1:1 as eluent.

¹H NMR (500 MHz, CDCl₃) δ 5.63 (d, J=3.8 Hz, 1H), 5.24 (dd, J=9.4, 6.5 Hz, 1H), 5.18 (t, J=9.5 Hz, 1H), 4.28 (dd, J=12.3, 5.1 Hz, 1H), 4.14 (dd, J=12.3, 2.4 Hz, 1H), 3.71 (m, 1H), 3.22-3.15 (m, 1H), 2.77 (dd, J=17.5, 11.8 Hz, 1H), 2.45 (dd, J=17.5, 8.6 Hz, 1H), 2.09 (s, 3H), 2.06 (s, 3H), 2.06 (s, 3H). ¹³C NMR (126 MHz, CDCl₃) δ 173.4, 170.6, 170.0, 169.6, 98.2, 71.4, 70.4, 65.3, 61.8, 40.1, 27.3, 20.7, 20.6, 20.6. HRMS (DART) m/z Calcd for C₁₄H₁₉O₉ [M+H⁺]: 331.10236; found: 331.10253.

Compound 4 was obtained in 9% NMR yield from P(Glu-CKA) and 62% NMR yield from P(Man-CKA) using the General Procedure of Acidic Degradation of Homopolymers, separated by PTLC with Hex: EA=1:1 as eluent. ¹H NMR (500 MHZ, C₆D₆) δ 5.09-5.02 (m, 2H), 4.86 (t, J=8.2 Hz, 1H), 4.27 (dd, J=12.5, 4.2 Hz, 1H), 3.88 (dd, J=12.4, 2.3 Hz, 1H), 3.45 (dt, J=9.7, 3.2 Hz, 1H), 2.25 (d, J=16.8 Hz, 1H), 1.77-1.63 (m, 5H), 1.61 (s, 3H), 1.58 (s, 3H). ¹³C NMR (126 MHZ, C₆D₆) δ 170.9, 169.9, 169.5, 169.2, 100.1, 71.9, 70.2, 67.2, 61.4, 40.1, 34.2, 20.3, 20.1, 20.1. HRMS (DART) m/z Calcd for C₁₄H₂₂NO₉ [M+NH₄⁺]: 348.12891; found: 348.12840.

Compound 5 was obtained in 78% NMR yield from P(Gal-CKA) using the General Procedure of Acidic Degradation of Homopolymers, separated by PTLC with Hex: Et2O=1:1 as eluent for five times. ¹H NMR (600 MHZ, CDCl₃) δ 5.63 (d, J=4.0 Hz, 1H), 5.37 (d, J=3.9 Hz, 1H), 5.24 (dd, J=6.5, 3.9 Hz, 1H), 4.16 (qd, J=11.5, 6.6 Hz, 2H), 3.95 (td, J=6.6, 1.4 Hz, 1H), 3.09 (dd, J=17.4, 11.4 Hz, 1H), 2.94-2.86 (m, 1H), 2.47 (dd, J=17.4, 8.5 Hz, 1H), 2.15 (s, 3H), 2.06 (s, 3H), 2.05 (s, 3H). ¹³C NMR (126 MHz, CDCl₃) δ 174.5, 170.4, 169.7, 169.6, 98.5, 70.8, 66.8, 65.4, 61.6, 37.7, 28.3, 20.7, 20.6, 20.6. HRMS (DART) m/z Calcd for C₁₄H₁₉O₉ [M+H⁺]: 331.10236; found: 331.10315.

Compound 6 was obtained in 20% NMR yield from P(Gal-CKA) using the General Procedure of Acidic Degradation of Homopolymers, separated by PTLC with Hex: Et2O=1:1 as eluent for five times. ¹H NMR (600 MHZ, CDCl₃) δ 5.92 (d, J=4.1 Hz, 1H), 5.39 (d, J=2.9 Hz, 1H), 4.80 (dd, J=10.6, 3.0 Hz, 1H), 4.27 (t, J=6.5 Hz, 1H), 4.18-4.11 (m, 2H), 2.82-2.70 (m, 2H), 2.55 (d, J=16.7 Hz, 1H), 2.15 (s, 3H), 2.07 (s, 3H), 2.04 (s, 3H). ¹³C NMR (126 MHz, CDCl₃) δ 171.4, 170.4, 170.1, 169.9, 101.1, 69.7, 69.5, 64.7, 61.6, 35.4, 34.6, 20.7, 20.6, 20.6. HRMS (DART) m/z Calcd for C₁₄H₁₉O₉ [M+H⁺]: 331.10236; found: 331.10300.

### Basic Degradation of P(Glu-CKA)

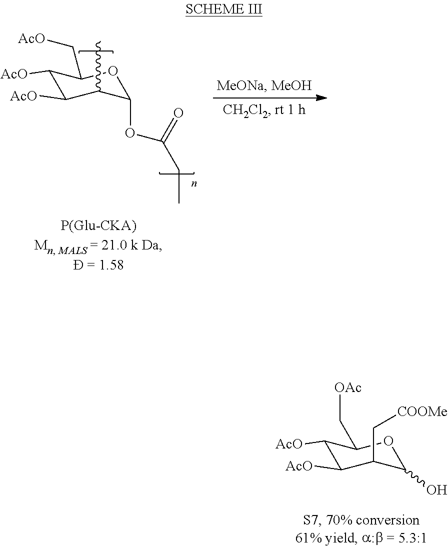

To a 7 mL vial, P(Glu-CKA) (100 mg, 300 μmol of repeating units), 1.5 mL methylene chloride, and sodium methoxide (1.64 mg, 30 μmol) in 1.5 mL methanol was added sequentially. The resulting mixture was allowed to stir at room temperature for 1 h, then concentrated by rotary evaporation. Next, ¹H NMR of the crude reaction mixture with added mesitylene as the internal standard showed 68% conversion and 61% NMR yield of 5 as a:b=5.3:1. Crude mixture was purified by column chromatography with 10% to 20% acetone in hexane as eluent to obtain compound S7 as a transparent liquid (35.8 mg, 50% yield). Other diastereomers were not observed after the basic degradation.

In CDCl₃, compound S7 exists at a 1:0.19 mixture of a: β diastereomers. ¹H NMR (600 MHz, CDCl₃) δ 5.53 (dd, J=9.7, 5.4 Hz, 1H), 5.27 (dd, J=3.4, 1.2 Hz, 1H), 5.15 (dd, J=10.0, 5.1 Hz, 0.2H), 5.07 (t, J=9.7 Hz, 1H), 5.05-4.98 (m, 0.4H), 4.68 (d, J=5.1 Hz, 0.2H), 4.23-4.11 (m, 3.6H), 3.72 (s, 0.6H), 3.70 (s, 3H), 3.68-3.65 (m, 0.2H), 3.08-3.04 (m, 1H), 2.95-2.91 (m, 0.2H), 2.90-2.80 (m, 1.2H), 2.69 (dd, J=17.0, 4.4 Hz, 1H), 2.60 (dd, J=16.7, 4.0 Hz, 0.2H), 2.48 (dd, J=17.1, 9.8 Hz, 1H), 2.11 (s, 3H), 2.10 (s, 0.6H), 2.04 (s, 3H), 2.03 (s, 1.2H), 2.02 (s, 3H). ¹³C NMR (126 MHz, CDCl₃) δ 174.7, 172.4, 170.8, 170.8, 169.9, 169.8, 169.7, 94.9, 94.2, 72.5, 71.9, 69.4, 68.3, 66.3, 65.8, 62.5, 62.5, 52.4, 51.9, 40.4, 39.8, 30.3, 26.9, 20.9, 20.8, 20.8, 20.7, 20.7. HRMS (DART) m/z Calcd for C₁₅H₂₆NO₁₀ [M+NH₄⁺]: 380.15512; found: 380.15494.

### Degradation Experiments of Copolymers

General Procedure of Degradation of Copolymers—To an oven-dried 8 mL culture tube, 20 mg copolymer, 0.5 mL CH₂Cl₂, and a stir bar was added. Next, a solution of MeONa (20 mg) in 0.5 mL MeOH was added. The culture tube was capped, and the reaction mixture was allowed to stir at room temperature for 16 hours. After the reaction finished, ion exchange resin (the proton form, ˜ 200 mg) was added, and reaction tube was shacked. Next, filtrate was collected after filtration with cotton to remove resin. The filtrate was concentrated by rotary evaporation and analyzed by SEC with DMF as the mobile phase.

Copolymers coP1, coP2, coP3, coP4, and coP5 were degraded following the procedure described above. All of copolymers and degradation product results were obtained by DMF GPC using the same methods.

Degradation of coP1 resulted in significant reduction of molecular weight from 70.3 KDa (Mₙ) to 9.2 KDa (Mₙ), indicating that ester groups were efficiently incorporated into the polymer backbone. Similarly, coP2, coP4, and coP5 showed, respectively, a reduction of Mₙ from 81.4 kDa to 16.3 kDa, 74.5 kDa to 6.7 kDa, and 55.1 kDa to 11.3 kDa. Further, the polydispersity index of coP1 was increased from 2.34 to 4.84 after the degradation. The same trend was observed when coP5 was degraded.

By contrast, comparative copolymer coP3 containing only MI and MMA, was poorly degradable in the same degradation study, showing a decrease of Mₙ from 158.8 kDa to 119 kDa, and a decrease of the polydispersity index from 3.95 to 2.93.

### OTHER EMBODIMENTS

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

From the above description, one skilled in the art can easily ascertain the essential characteristics of the present invention, and without departing from the spirit and scope thereof, can make various changes and modifications of the invention to adapt it to various usages and conditions. Thus, other embodiments are also within the claims.

What is claimed is:

1. A polymer comprising at least 10 repeat units, each of which contains an acetyl moiety —CR₁R₂C(O)— and a saccharide moiety,
wherein
the acetyl moiety and the saccharide moiety are bonded to each other through an ester bond —C(O)—O—, —C(O)— being a part of the acetyl moiety and —O— being a part of the saccharide moiety, and
each of R₁ and R₂, independently, is H, halo, C₁-C₃ alkyl, or phenyl.

2. The polymer of claim 1, wherein the saccharide moiety is derived from glucose, mannose, galactose, rhamnose, xylose, arabinose, lactose, maltose, or glucosamine.

3. The polymer of claim 1 having the following repeat units containing a pyranose ring and the acetyl moiety: 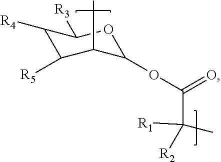
in which each of the bonds connecting to the pyranose ring is either axial or equatorial; and R₃ is H, CH₃, or CH₂OR₃′, R₄ is OR₄′, R₅ is OR₅′, and each of R₃′, R₄′, and R₅′, independently, is H, acetyl, benzyl, pivaloyl, benzoyl, C₁-C₆ alkyl, or a monosaccharide substituent.

4. The polymer of claim 3, wherein the monosaccharide substituent is a glucose substituent or a galactose substituent.

5. The polymer of claim 3, wherein each of R₁ and R₂ is H, R₃ is H, CH₃, or CH₂OR₃′, R₄ is OR₄′, R₅ is OR₅′, and R₃′ is H, acetyl, benzyl, pivaloyl, benzoyl, methyl, or ethyl; R₄′ is H, acetyl, benzyl, pivaloyl, benzoyl, methyl, ethyl, a glucose substituent, or a galactose substituent; and R₅′ is H, acetyl, benzyl, pivaloyl, benzoyl, methyl, or ethyl.

6. The polymer of claim 1, wherein each of the repeat units is

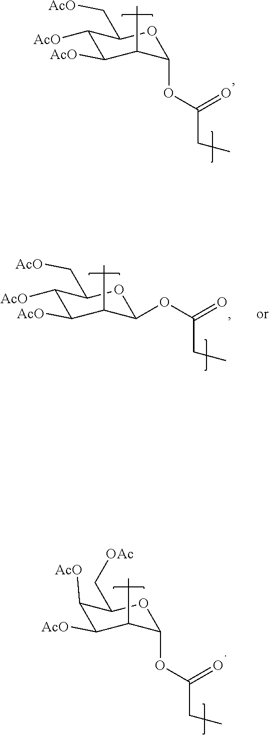

7. The polymer of claim 1, wherein the number average molecular weight of the polymer is 3,000 Da to 50,000 Da.

8. The polymer of claim 1, wherein the polymer is a co-polymer further comprising one or more repeat units derived from a vinyl monomer.

9. The polymer of claim 8, wherein the vinyl monomer is an acrylate, an acrylamide, an maleimide, a styrene, vinyl acetate, or vinyl amide.

10. The polymer of claim 1, wherein the polymer is a co-polymer further comprising (i) one or more repeat units derived from methyl acrylate, ethyl acrylate, 2-ethylhexyl acrylate, butyl acrylate, trimethylolpropane triacrylate, methyl methacrylate, ethyl methacrylate, butyl methacrylate, hydroxyethyl methacrylate, glycidyl methacrylate, N,N-dimethyl acrylamide, styrene, vinyl acetate, or N-vinylcarbazole and (ii) one or more repeat units derived from N-phenylmaleimide or N-methylmaleimide.

11. The polymer of claim 10, wherein the polymer has the following structure: 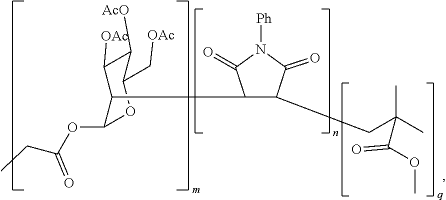
in which Ac is acetyl, Ph is phenyl, m:n:q is 1:(0-10):(0-30), and n and q are not both 0.

12. The polymer of claim 11, wherein the number average molecular weight is 3,000 Da to 1,000,000 Da.

13. A method of preparing the polymer of claim 1, the method comprising the steps of:
(i) providing a reaction mixture containing a saccharide-ketene acetal comprising a saccharide moiety and a ketene acetal moiety, wherein the saccharide moiety has a pyranose or furanose ring having C1 and C2 positions, and the ketene acetal moiety connects to the saccharide moiety through two ether bonds on the C1 and C2 positions, and
(ii) initiating a radical ring-opening polymerization reaction, thereby obtaining the polymer of claim 1.

14. The method of claim 13, wherein the saccharide moiety is derived from a monosaccharide having a pyranose ring and the ketene moiety is bonded to the pyranose ring on both the C1 and C2 positions to form a five membered cyclic ketene acetal.

15. The method of claim 13, wherein the saccharide moiety is derived from glucose, mannose, galactose, rhamnose, xylose, arabinose, lactose, maltose, or glucosamine.

16. The method of claim 13, wherein the reaction mixture further comprising a vinyl monomer and a maleimide monomer.

17. The method of claim 13, wherein the reaction mixture contains a RAFT reagent that is

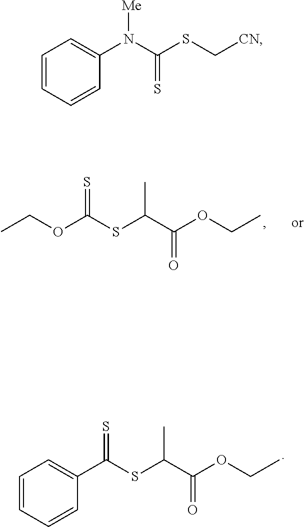 [SMILES: CN(C(=S)SCC#N)c1ccccc1 ; CCOC(=O)C(C)SC(=S)OCC ; CCOC(=O)C(C)SC(=S)c1ccccc1]

18. The method of claim 13, wherein the saccharide-ketene acetal is prepared by reacting a saccharide halide having a halide on the C1 position and O-acetyl on the C2 position, and the halide and O-acetyl are on the same side of the pyranose ring.

19. The method of claim 13, wherein the initiating step is achieved through adding a radical initiator at a temperature of 35° C. or higher.

20. The method of claim 19, wherein the radical initiator is 2.2′-azobisisobutyro-nitrile (AIBN) and the temperature is 40° C. to 140° C.
